(19) United States
(12) Patent Application Publication
(10) Pub. No.: US 2007/0239528 A1
(43) Pub. Date: Oct. 11, 2007

(54) Dynamic proxy method and apparatus for an online marketing campaign

(75) Inventors: Shunxing Xie, Northridge, CA (US); Robert Kendrick Spitz, Amherst, NH (US); Michael L Kline, Bell Canyon, CA (US)

Correspondence Address: BEYER WEAVER LLP, P.O. BOX 70250, OAKLAND, CA, 94612-0250, US

(73) Assignee: ReachLocal, Inc.

(21) Appl. No.: 11/393,208

(22) Filed: Mar. 29, 2006

(51) Int. Cl. G06Q 30/00

(52) U.S. Cl. 705/14

(57) ABSTRACT

Disclosed are methods and apparatus, including computer program products, implementing and using techniques for dynamic network address identification and replacement for delivering a web page to a data processing device associated with a customer, for performing a marketing campaign on behalf of an advertiser. A browser request message is received over a data network from a browser program executing on the data processing device. The browser request message requests an origin web page at an origin web site on the data network. The origin web site is associated with the advertiser. A network address of the origin web site on the data network is determined. Responsive to the browser request message, content of the origin web page is retrieved from the origin web site at the determined network address. A network address is located in the retrieved content of the origin web page. The located network address is replaced with a proxy network address to define a modified web page. The proxy network address references a proxy web site on the data network. The modified web page is provided to the data processing device over the data network.

### CROSS-REFERENCE TO RELATED APPLICATIONS

The present application relates to commonly assigned, copending U.S. patent applications No. 10/956,554, filed Oct. 1, 2004 for METHOD AND APPARATUS FOR PERFORMING A MARKETING CAMPAIGN ON BEHALF OF AN ADVERTISER (Attorney docket no. REACP001), No. 10/956,558, filed Oct. 1, 2004 for METHOD AND APPARATUS FOR ALLOCATING A CAMPAIGN BUDGET AMONG PUBLISHERS FOR A MARKETING CAMPAIGN (Attorney docket no. REACP002), No. 10/956,557, filed Oct. 1, 2004 for METHOD AND APPARATUS FOR GENERATING ADVERTISEMENT INFORMATION FOR PERFORMING A MARKETING CAMPAIGN (Attorney docket no. REACP003), No. 10/956,553, filed Oct. 1, 2004 for METHOD AND APPARATUS FOR TRACKING AND REPORTING CAMPAIGN STATUS INFORMATION FOR A MARKETING CAMPAIGN (Attorney docket no. REACP004), and No. 10/956,824, filed Oct. 1, 2004 for METHOD AND APPARATUS FOR DYNAMICALLY RENDERING AN ADVERTISER WEB PAGE AS A PROXIED WEB PAGE (Attorney docket no. REACP005). The disclosures of the above-listed applications are all incorporated herein by reference in their entirety for all purposes.

### FIELD

The present invention generally relates to online marketing campaigns. More particularly, the present invention relates to dynamic proxy methods and apparatus for implementing and monitoring an online marketing campaign.

### BACKGROUND

Before the widespread availability of the Internet, advertisers reached potential customers using conventional advertising techniques: printed advertisements in newspapers and magazines, direct mailings, television commercials, radio commercials, yellow pages advertisements, sponsorships, etc. These conventional media channels were “offline” in nature, that is, information was communicated between the advertiser and potential customer over communications channels other than data networks such as the Internet. For most merchants, conventional offline advertising techniques were local in nature. The advertisements were distributed within a limited local geographic area, typically on a town, city or county level. A dentist reached patients by purchasing an advertisement in the local yellow pages. A used car dealer reached car buyers using a television commercial on a local station, an ad in the city newspaper, and/or sponsorship of a local athletic team.

With the advent of the Internet, many advertisers have achieved success on a national and international level. These advertisers have focused their marketing to reach customers on the Internet, regardless of the advertisers' or customers' geographical location. “Dot-com merchants” purchase banners and other advertisements for display by search engines, online directories, and various other web sites. The advertisement is displayed on a potential customer's personal computer when a browser program on the personal computer, operated by the user, accesses the web site, or runs a search on the search engine using keywords associated with the advertiser. National and international merchants, particularly those selling products by mail order, have benefited greatly from Internet advertising, which has essentially removed the geographical constraints associated with conventional advertising.

Nonetheless, while the Internet has taken advertising to a global level, it is estimated that a large percentage of merchant searches performed on the Internet are still primarily local in nature. Many local consumers still prefer to do business with local merchants.

Many local merchants have refrained from establishing an online presence, and continued to use only the conventional offline advertising techniques described above. Local business owners believe it is simply not worth the time, effort and cost to learn about internet advertising, decide on the appropriate publishers, e.g., search engines, online directories, other advertising web pages, and then figure out how to advertise on those sites. For example, local merchants can be unclear as to which keywords to use, how much to spend on each keyword, etc. Also, most local merchants do not have the time or means to decide how to allocate a budget for the different publishers and different types of advertisements. In addition, local merchants are unsure as to how to target online advertisements to a specific geographic area. Further, local merchants are unable to track new customers reached and acquired through online advertisements. Because of all of these issues and uncertainties, most local merchants decide that it is not worth the trouble to engage in online advertising.

By foregoing Internet advertising, many local merchants cannot reach an increasing number of local customers who prefer to shop online. These local customers have taken to using the Internet not only during their leisure time, but also as a matter of course in their lives. Nowadays, many local customers looking for a car dealer, dentist, lawyer, hair salon, handyman, restaurant, exercise club, or other local merchant, will start their search on the Internet. The Internet has become so integrated with people's daily lives, that many potential customers begin a search for essentially anything by accessing an online directory or an Internet search engine and entering the appropriate keywords. Local businesses and merchants who fail to establish an online presence and conduct online advertising, or fail to do so in an effective manner, will fail to reach these potential customers.

When a local merchant establishes an online presence and marketing campaign, one of the primary concerns then becomes monitoring the success of the campaign. To monitor the campaign's success, it is desirable to monitor customer activity on various levels. For instance, depending on the marketing campaign, it may be desirable to monitor which web sites the potential customer accesses, which pages on that site are accessed, the number of times the sites and particular pages are accessed, whether the potential customer responds to advertisements by contacting the advertiser, by what means the customer contacts the advertiser, e.g., phone, email, online form submission, any online purchases made on the advertiser web site, and other user activity. Based on this information, the advertiser can evaluate the success of the campaign and re-structure the campaign, if desired, to make the campaign more effective. Without information monitoring potential customer activity, however, the advertiser is left to guess what, if any, impact the online advertising campaign has on its sales.

What are needed are effective techniques for identifying, gathering, and measuring data associated with potential customer activity responsive to an online advertising campaign.

### SUMMARY

Aspects of the present invention relate to methods and apparatus, including computer program products, implementing and using techniques for dynamic network address identification and replacement for delivering a web page to a data processing device associated with a customer, for performing a marketing campaign on behalf of an advertiser.

According to one aspect of the present invention, a browser request message is received over a data network from a browser program executing on the data processing device. The browser request message requests an origin web page at an origin web site on the data network. The origin web site is associated with the advertiser. A network address of the origin web site on the data network is determined. Responsive to the browser request message, content of the origin web page is retrieved from the origin web site at the determined network address. A network address is located in the retrieved content of the origin web page. The located network address is replaced with a proxy network address to define a modified web page. The proxy network address references a proxy web site on the data network. The modified web page is provided to the data processing device over the data network.

According to another aspect of the present invention, a browser request message is received over the data network from a browser program executing on the data processing device. The browser request message requests an origin web page at an origin web site on the data network. The origin web site is associated with the advertiser. A network address of the origin web site on the data network is determined. Responsive to the browser request message, content of the origin web page is retrieved from the origin web site at the determined network address. It is determined whether one or more limiting criteria are exceeded. When it is determined that the one or more limiting criteria are exceeded, the origin web page is provided to the data processing device over the data network. When it is determined that the one or more limiting criteria are not exceeded, a network address in the retrieved content of the origin web page is located. The located network address is replaced with a proxy network address to define a modified web page. The proxy network address references a proxy web site on the data network. The modified web page is provided to the data processing device over the data network.

According to another aspect of the present invention, a data processing apparatus includes an interface in communication with the data network. The interface is capable of receiving a browser request message from a browser program executing on the data processing device. The browser request message requests an origin web page at an origin web site on the data network. The origin web site is associated with the advertiser. The data processing apparatus further includes a memory, which stores instructions, and a processor in communication with the interface and the memory. The processor is operable to receive the browser request message from the interface, load the instructions from the memory responsive to receiving the browser request message, and execute the instructions to: (1) determine a network address of the origin web site on the data network, (2) retrieve, responsive to the browser request message, content of the origin web page from the origin web site at the determined network address, and (3) determine whether one or more limiting criteria are exceeded. When it is determined that the one or more limiting criteria are exceeded, the origin web page is provided to the data processing device over the data network. When it is determined that the one or more limiting criteria are not exceeded, a network address is located in the retrieved content of the origin web page. The located network address is replaced with a proxy network address to define a modified web page. The proxy network address references a proxy web site on the data network. The modified web page is provided to the data processing device over the data network.

### BRIEF DESCRIPTION OF THE FIGURES

FIG. 1 shows a block diagram of an online advertising system 100, constructed according to one embodiment of the present invention.

FIG. 2 shows a block diagram of an online advertising system 200, including a dynamic proxy server, constructed according to one embodiment of the present invention.

FIG. 3 is an illustration of a group of origin web sites and a group of proxy web sites corresponding to the origin web sites on one or more servers, according to one embodiment of the present invention.

FIG. 4 shows a flow diagram of a method 400 for identifying and including web sites in a proxy web site group 350, performed in accordance with one embodiment of the present invention.

FIG. 5 shows a flow diagram of a method 500 of responding to a user request for advertiser data, performed in accordance with one embodiment of the present invention.

FIG. 6 shows a flow diagram of a method 600 of performing a content type check for content retrieved from an original web site, performed in accordance with one embodiment of the present invention.

FIG. 7 shows flow diagram of a method 635 of HTML page processing, performed in accordance with one embodiment of the present invention.

FIG. 8 shows a flow diagram of a dynamic URL processing method 730, performed in accordance with one embodiment of the present invention.

FIG. 9 shows a flow diagram of a method 650 for performing image processing, in accordance with one embodiment of the present invention.

FIG. 10 shows a flow diagram of a method 665 for performing Flash processing, in accordance with one embodiment of the present invention.

FIG. 11 shows a flow diagram of a method 685 for performing Flash AMF message processing, in accordance with one embodiment of the present invention.

### DETAILED DESCRIPTION

Embodiments of the present invention can be implemented in conjunction with an advertising scheme in which it is desired to monitor potential customer activity responsive to an online advertising campaign, in which advertisers can reach customers over data networks such as the Internet. In some implementations, embodiments of methods and apparatus of the present invention are practiced in conjunction with an advertising platform as described in U.S. patent application Ser. No. 10/956,824, filed Oct. 1, 2004 for METHOD AND APPARATUS FOR DYNAMICALLY RENDERING AN ADVERTISER WEB PAGE AS A PROXIED WEB PAGE (Attorney docket no. REACP005), which is incorporated herein by reference in its entirety for all purposes.

Embodiments of methods and apparatus of the present invention facilitate online advertising campaigns by providing a customer web site, referred to herein as an “origin” site or “source” site, to be hidden behind a placeholder web site, referred to herein as a “proxy” web site. Certain web site elements, including contents and events, can be changed and/or monitored to effectively measure end user activity during an advertising campaign. These elements include phone numbers, emails, and tracking which web pages are viewed, as well as web pages that are acted upon. A web page which is acted upon usually involves an end customer filling out a form, or an online purchase made on the web site.

Web site content often includes HTML pages as well as images (e.g. GIF, JPEG or PNG format). Those skilled in the art will appreciate that principles of the present invention are applicable to other data files and pages accessible over data networks, that are presently available or may be later developed. HTML pages may be generated by suitable methods at the origin site including static html, or dynamic methods such as perl, php, asp, coldfusion, etc. Methods and apparatus of embodiments of the present invention are capable of using the resulting HTML page generated by the origin site, regardless of how the HTML page was generated. HTML content on the HTML page can contain email links and embedded scripts, most often written in JavaScript or other DHTML extensions. Some web sites also deliver content in Macromedia Flash or AMF, which is a commonly used web plug-in. Flash allows fancy text and pictures, animations, sound. Flash content is contained in separate Flash files which are often sent from the origin web site and played on the user browser.

Sometimes one or more interdependent web sites may be linked to an origin site in a single advertising campaign. For example, a local automobile dealer web site may have links to related sites including a corporate new car site, a used car site, and an automobile financing site. When a user browser accesses the origin site, in this case, the local dealer site, the user may click on the links on the local dealer site to be directed to the other related sites. The links may be located anywhere on the local dealer site, not necessarily on the entry page. Also, the links may be contained in HTML code, JavaScript, or Flash content. The flow of the user browser will often be to any of related sites and then back to the entry site. Embodiments of methods and apparatus of the present invention provide for defining one or more of the related sites as a proxy group, so that user activity on all of the sites in the proxy group can be monitored.

Embodiments of methods and apparatus of the present invention provide an online advertising campaign in which a URL link, often in the form of an advertisement or listing, is provisioned at an online publisher, e.g., Google, Yahoo, and/or a suitable online directory. Unbeknownst to the user, the URL provisioned at the publisher is linked to a proxy server rather than the advertiser's origin site. For example, a flower supplier has an origin site located at http://www.flowerdealer.com. A proxy site called http://flowerdealer.reachlocal.net is created, and the URL provisioned at the publisher links to the proxy site, http://flowerdealer.reachlocal.net rather than the origin site, http://www.flowerdealer.com. Thus, when the user clicks on the publisher's URL link, associated with the origin site, a browser request message responsive to the user click is directed to the proxy site. According to methods and apparatus of the present invention, when the request message requests a page on the proxy site, e.g. http://flowerdealer.reachlocal.net/roses.html, the proxy server determines a mapping back to the source site and dynamically fetches the equivalent page on the source site, that is, http://www.flowerdealer.com/roses.html.

According to embodiments of methods and apparatus of the present invention, the proxy server scans the retrieved page or pages from the origin site and makes any desired substitutions to the page contents. These substitutions can include content such as phone numbers, email links, images, or hyperlinks to other pages on the web site, or to other web sites. The substituted page contents are then returned to the end user web browser for display and execution on a computer operated by the user. In this way, for example, any phone numbers displayed on the origin web site page can be replaced with tracking phone numbers set up for the campaign. Also, email links can be replaced to redirect the web browser through a tracking form mail server, and URL links to other related sites will be replaced with links to an equivalent proxy site. In some embodiments, the proxy server also monitors certain page URLs which have been defined for tracking. If one of these pages is referenced via a “get” or “post” operation, then a conversion page event can be logged in the proxy system event log. These logs can be used for user campaign tracking and budget optimization purposes.

According to embodiments of methods and apparatus of the present invention, an individual proxy, or “hard proxy” is preferably defined for each web site in the campaign. An entry proxy server, often corresponding to the advertiser's origin web site, is called the primary proxy for a campaign. For additional web sites involved in the campaign, a secondary level proxy can be added to that campaign's proxy group. For example, if a related site, http://www.tulips.com is referenced by the origin site, then a proxy server can be created, for example, http://tulips.reachlocal.net. So when any page is accessed from the proxy associated with the origin site http://www.flowerdealer.com or any related site such as http://www.tulips.com, any reference to them is replaced with http://flowerdealer.reachlocal.net or http://tulips.reachlocal.net, respectively. Clicking on such a link takes the user browser to a proxied version of the related site.

By modifying an advertiser web site to define a proxy web site, embodiments of methods and apparatus of the present invention enable monitoring of campaign events such as customer interactions, e.g., emails, phone calls, coupon registration, accessing of designated HTML pages, etc. Thus, the overall effectiveness of the marketing campaign can be monitored.

Embodiments of methods and apparatus of the present invention provide automatic detection of Flash or AMF contents on a web site. Upon detection, the contents are scanned, and a replacement version is created with appropriate content substitutions made. The altered Flash file can be cached and served when the original Flash file is requested by a web page involved in the campaign. In some embodiments, when Flash contents are detected on an origin site page, the cache memory is checked for a replacement Flash file. When the replacement file exists, then it is served in response to the request. When no replacement file exists, the Flash file is de-compiled and scanned for content to be replaced. When no data to be replaced is found, a flag can be set to signal that no replacement is needed. Future access attempts will respond to the flag, so no scans will be done for that file. When content substitution is needed, the proxy system makes appropriate changes to the related content, e.g., phone number, URL links, etc. The replacement version is compiled and stored in the Flash file cache. Future access to the original flash file will retrieve the cached replacement Flash file and serve it without the need for additional scanning.

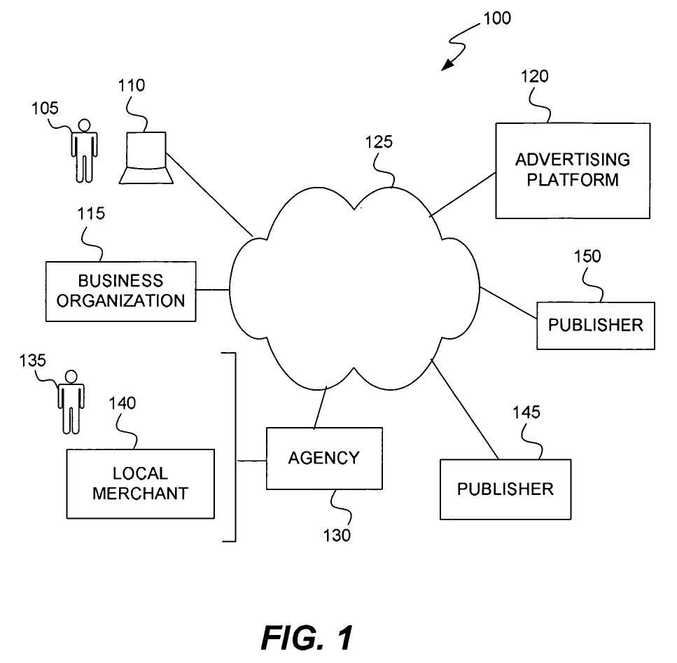

FIG. 1 shows an advertising system 100, constructed according to one embodiment of the present invention. The advertising system 100 of FIG. 1 is further described in U.S. patent application Ser. No. 10/956,824, filed Oct. 1, 2004 for METHOD AND APPARATUS FOR DYNAMICALLY RENDERING AN ADVERTISER WEB PAGE AS A PROXIED WEB PAGE (Attorney docket no. REACP005). In FIG. 1, individual advertisers such as person 105 operating a personal computer 110, and business organization 115, can access advertising platform 120 implemented on one or more servers over data network 125. Personal computer 110 is in communication with data network 125 by any suitable means. Data network 125 is any suitable network for sending and receiving data, such as the Internet. An advertising agency 130 can access advertising platform 120 in a similar manner as individual advertisers 105 and 115. In this embodiment, advertising agency 130 represents several individual advertisers, including person 135 and local merchant 140.

In FIG. 1, publishers 145 and 150 such as Google, Yahoo!, or an online yellow pages, are also in communication with data network 125. The publishers 145 and 150 are capable of interfacing with advertising platform 120, using techniques described in U.S. patent application Ser. No. 10/956,824, filed Oct. 1, 2004 for METHOD AND APPARATUS FOR DYNAMICALLY RENDERING AN ADVERTISER WEB PAGE AS A PROXIED WEB PAGE (Attorney docket no. REACP005), to display advertisements on behalf of one or more advertisers. In one embodiment, the publishers 145 and 150 interface with advertising platform 120 over data network 125, as shown in FIG. 1. In an alternative embodiment, publishers 145 and 150 interface directly with advertising platform 120 over any suitable communications link.

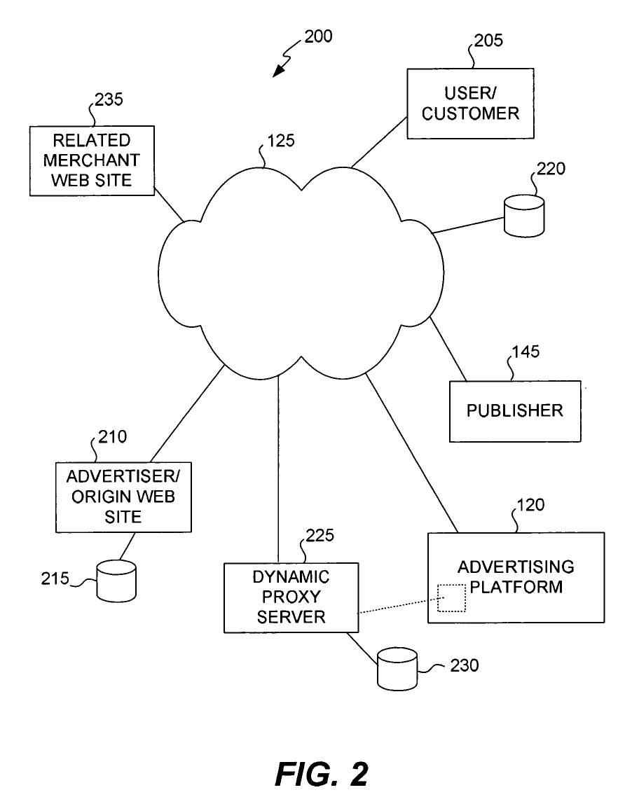

FIG. 2 shows a block diagram of an online advertising system 200, including a dynamic proxy server, constructed according to one embodiment of the present invention. In system 200, a publisher 145 and advertising platform 120 are in communication with data network 125, as described above with respect to FIG. 1. A user, e.g., potential customer 205, operating a web browser program on a personal computer or other suitable data processing device, is in communication with data network 125. An advertiser web site 210, e.g., origin site, operated by an advertiser desiring to conduct an online marketing campaign, stores HTML pages and other data on an accessible storage medium, such as memory device 215.

In FIG. 2, system 200 includes a dynamic proxy server 225 which implements the dynamic proxy methods and apparatus of embodiments of the present invention. In an alternative embodiment, dynamic proxy server 225 is implemented on one or more computers, such as a server, or other data processing apparatus. In one embodiment, dynamic proxy server 225 is implemented as a part of advertising platform 120. In other alternative embodiments, dynamic proxy server 225 is implemented in a separate location from advertising platform 120. Dynamic proxy server 225 is operatively coupled to a proxy web site storage medium 230. Proxy storage medium 230 stores proxy web site information corresponding to origin web site 210 and any related sites 235 linked to the advertiser web site 210. In preferred embodiments, caching storage is provided within proxy server 225 to maintain cached copies of HTML data, images, and Flash or AMF objects. Thus, rather than have to fetch original contents every time data is requests, cached copies of the requested data can be returned for faster response time.

In FIG. 2, a customer request message from customer 205 is received by dynamic proxy server 225. In some embodiments, the customer request message is a browser request for data at a URL linked to an advertisement or other item displayed on a publisher web site 145, responsive to the user clicking on the item. The browser request is routed to dynamic proxy server 225. Responsive to the browser request, the dynamic proxy server 225 retrieves an advertiser web page referenced by the browser request from where it is ordinarily stored, for instance, storage medium 215.

In FIG. 2, in some embodiments, the dynamic proxy server 225 dynamically edits the advertiser web page, as explained below, to create a proxied web page, and sends the proxied page back to the browser. In one example, the dynamic editing includes filtering the content of the advertiser web page. For instance, contact information on that page can be identified using conventional pattern recognition techniques. Examples of such identified contact information include phone numbers, email addresses, images, and other numbers including fax numbers, cell phone numbers, and any other means for contacting the advertiser. The numbers on the advertiser web page are characterized herein as “target” phone numbers, referring to the actual telephone number at which the advertiser can respond to a customer. The identified contact information is replaced with appropriate tracking phone numbers. These tracking phone numbers are intermediary phone numbers through which the customer interaction will be routed to gather information about the customer interaction.

In other examples, the dynamic editing includes replacing a price on the advertiser web page. For instance, the price can be associated with an item in inventory that is displayed only to customers accessing the page via an advertisement from the marketing campaign. Another example of dynamic editing the advertiser web page is inserting or replacing electronic coupons.

The proxy system includes a data collection engine that collects data for various types of campaign events such as emails sent by customers to advertisers, special coupons printed, and web pages tracked by the proxy system. For each event type, pertinent information such as phone numbers, email addresses, and other contact information as described above, is recorded in the proxy event log for use by campaign reporting systems.

In one embodiment, the data collection engine is triggered every time the tracking phone number is used by customer 205 and other customers. The proxy system interfaces with various 3^{rd} party calling services to provision and manage redirect phone calls through their telephone networks. These services track the phone calls that they handle. These phone events are use by proxy reporting systems to provide call information related to the campaign to the agencies and advertisers who are running the campaign. The data collection engine collects additional information from the call redirect service, including the customer's phone number, other customer identification information, date and time of the contact, and the duration of the contact.

Email substitutions and phone number substitutions can be made by simply replacing the identified contact information in the advertiser web page with tracking phone numbers in standard email and phone number formats. In certain instances, graphical images displayed on the advertiser web page may contain phone numbers and/or email addresses within. In these situations, an optical character recognition (OCR) operation is performed to identify those email addresses and phone numbers. Then the identified contact information can be replaced accordingly. In one embodiment, the tracking phone numbers and data collection engine described herein can be obtained through third party providers.

The dynamic proxy server 225 serves the proxied web page to the user browser 205 over data network 125. In some implementations, the customer receives the proxied web page not knowing that the dynamic editing described above has taken place. The editing is seamless, and provides the benefit of gathering information for the advertiser without interfering with the customer's experience.

As explained in greater detail below, when the user browser 205 requests HTML pages, images, Flash or AMF objects, or other data, the dynamic proxy server 225 generally fetches the requested data from its original location, e.g., origin storage medium 215, modifies the data, and returns the modified data. In some instances, however, when the requested data was previously modified, the modified data is retrieved from a cache memory in which the modified data was stored. As explained in greater detail below, when the user clicks on a link on the modified page, for example, the link has been previously been altered by the proxy server to route the associated browser request message to the dynamic proxy server 225. Thus, the dynamic proxy server can continue to monitor the user's activity with respect to the advertising campaign.

According to embodiments of methods and apparatus of the present invention, the dynamic proxy server 225 is operatively coupled to identify web sites referenced from an origin web site and create and provision proxy servers for the identified web sites. In one embodiment, the proxy server 225 is configured to run in dynamic site detect mode. In this case, the proxy server 225 will automatically scan a primary proxy site for external web site links and if the correct conditions exist, it will create a dynamic proxy server for them and add them to that campaign's proxy group.

In one example, as mentioned above, an advertiser web site 210 has the URL, http://www.flowerdealer.com. The dynamic proxy server 225 configures a corresponding proxy web site, http://flowerdealer.reachlocal.net. The proxy web site is set to dynamically detect related web sites referenced on the advertiser web site. In this example, the advertiser web site 210 has external references to the web sites, http://www.tulips.com, http://www.shipflowers.com, and http://www.cnn.com. When a page on the proxy web site, http://flowers.reachlocal.net, is accessed by the end user 205, the proxy server 225 determines a mapping back to the origin site 210 and dynamically fetches an equivalent page, e.g., http://www.flowers.com/roses.html. In one embodiment, this static mapping is maintained in a cache file which can be dynamically updated as needed. The proxy server 225 scans the results from roses.html and makes substitutions to the page contents as described above, e.g., phone numbers, email links, custom stings, etc. When running in dynamic site detect mode, the proxy server 225 identifies all URL links on the original page. When a URL link is not affected by standard processing, then a dynamic link replacement algorithm can be used. When the identified URL is not in an exception list, and other conditions are met, the algorithm will replace the identified URL link with a specially formatted replacement link. For instance, when a link to a related merchant web site 235, http://www.tulips.com, is identified, the identified link will be replaced with the proxy link, http://urlwww--tulips--com.reachlocal.net.

Continuing with the example, the sub-domain field of the proxy link “urlwww--tulips--com” provides an encoded version of the related merchant web site URL for encoding/decoding of the origin site. When the hyperlink is selected by the user, the user browser program will access the proxy server 225, http://urlwww--tulips--com.reachlocal.net. The proxy server 225 identifies the special format of the sub-domain and creates a dynamic mapping between http://urlwww--tulips--com.reachlocal.net and http:www.tulips.com. This same methodology generally applies for any hyperlink on any origin web page. As used herein, “origin web page” refers to pages retrieved from either a hard proxy or another dynamic site detect secondary proxy. The methodology generally applies to any object reference, including both hyperlinks and references to absolute content such as images and other external files.

Returning to the example above, references to http://www.shipflowers.com would become http://urlwww--shipflowers--com.reachlocal.com. In one embodiment, as described in greater detail below, the link http://www.cnn.com is mentioned in the exception list and, therefore, would not be replaced. Other criteria can be defined for links to not be replaced, as described in greater detail below.

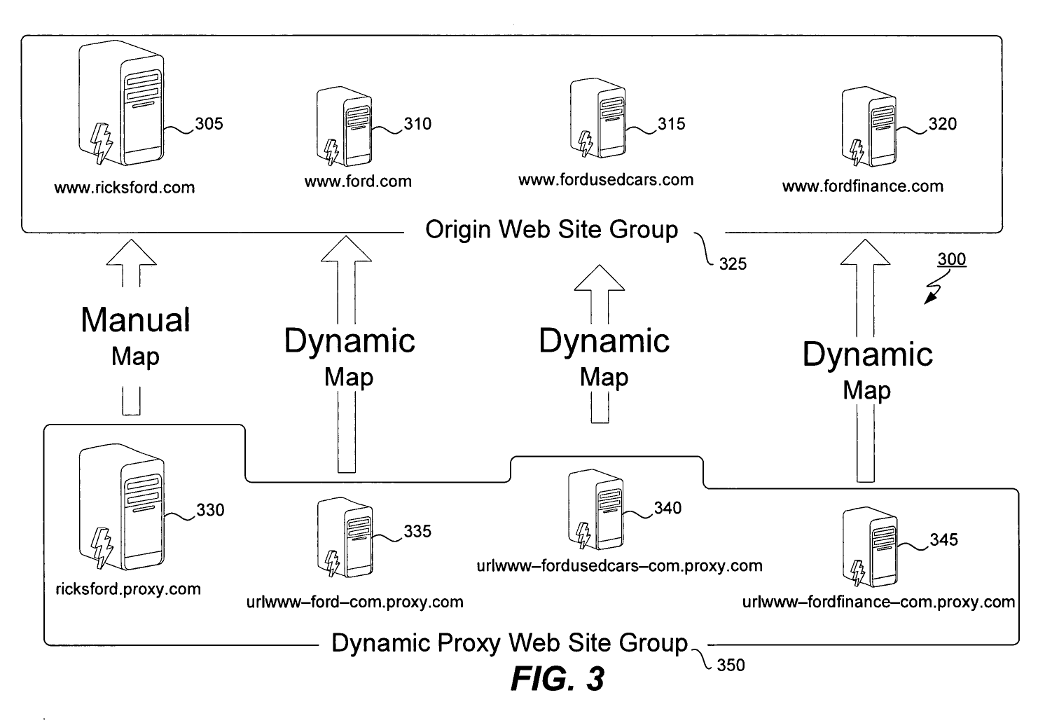

FIG. 3 is an illustration of a group of origin web sites and a group of proxy web sites corresponding to the origin web sites on one or more servers, defined according to one embodiment of the present invention. In FIG. 3, an advertiser operates its own web site on a server at the URL, www.ricksford.com. Web pages on the www.ricksford.com server reference other web sites maintained on behalf of other organizations or entities, such as merchants, separate from www.ricksford.com. For instance, the www.ricksford.com home page may contain references to an automobile supplier 310 at www.ford.com, a used car dealer 315 at www.fordusedcars.com, and lender server 320, at www.fordfinance.com. Methods and apparatus of embodiments of the present invention provide for identifying the web sites 310-320 referenced on the advertiser server 305 to define these web sites 305-320, collectively, as an origin web site group 325, also referred to herein as an origin group.

In FIG. 3, embodiments of methods and apparatus of the present invention provide for defining proxy web sites corresponding to the origin web sites 305-320. For example, a proxy web site for www.ricksford.com 305 can be defined on a proxy server at the URL, www.ricksford.proxy.com 330. Similarly, proxy web sites can be defined respectively for the remaining web sites 310-320 in the origin web site group 325. That is, a proxy of www.ford.com 310 is defined at URL, urlwww--ford--com.proxy.com 335. Similarly, the proxy site urlwww--fordusedcars--com.proxy.com 340 is defined as a proxy of www.fordusedcars.com 315, and urlwww--fordfinance--com.proxy.com 345 is defined as a proxy of server www.fordfinance.com 320. The proxy sites for the referenced web sites 310, 315 and 320 on www.ricksford.com 305 can be defined dynamically, as explained below. When the proxy web sites 330-345 are defined, these sites 330-345 can be collectively defined as a proxy web site group 350, also referred to herein as a proxy group.

In FIG. 3, the block diagram 300 shows a sample group of origin web sites 305-320 for an online advertising campaign. In this example, the campaign uses four different web sites. Generally the entry site, or starting point for monitoring user activity in the campaign is the advertiser web site, www.ricksford.com 305, when the user first visits the advertiser web site. One or more pages at www.ricksford.com 305 have hyperlinks to the other several sites 310-320. Those sites in turn may also have hyperlinks to additional web sites. Methods and apparatus of embodiments of the invention, as described below, provide decision logic for determining which, if any, additional web sites can be included in the origin web site group 325.

In FIG. 3, in one embodiment, preferably the name of a given proxy web site in proxy group 350 is a simple extension of the corresponding origin web site in origin group 325. In one embodiment, as shown in FIG. 3, there is a one-to-one correspondence between each proxy web site 330-345 in the proxy group 350 and the origin web sites 305-320 in the origin group 325. Those skilled in the art will appreciate that proxy web sites in the proxy group 350 can be organized and defined on one or more servers, as desired for the particular implementation. For instance, several proxy sites in proxy group 350 can be situated on the same physical server.

In FIG. 3, in one embodiment, the naming of each proxy server 330-345 is an encoded version of the name of its corresponding web site 305-320. For instance, the proxy at URL urlwww--ford--com.proxy.com 335 corresponds to www.ford.com 310. Often, the proxy site 330 corresponding to the entry site 305 is manually configured. The other proxy sites 335-345 corresponding to sites 310-320 referenced at entry site 305, however, can be dynamically discovered and defined in real time, as explained below. Those skilled in the art will appreciate that the phrase “proxy.com” as used in the URLs of proxy sites 330-345 in proxy group 350 can be any arbitrary domain name, as specified for the particular implementation, for instance, “reachlocal.net.”

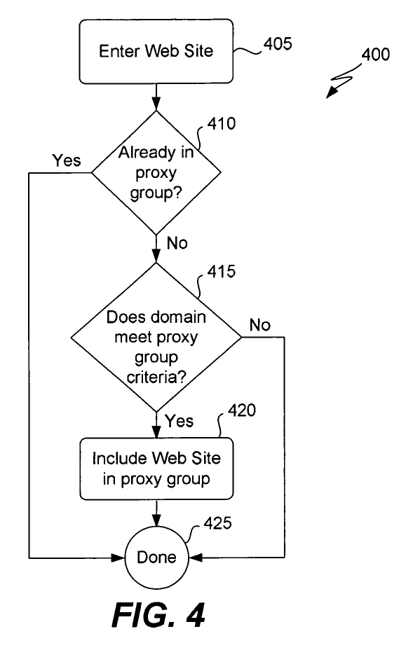

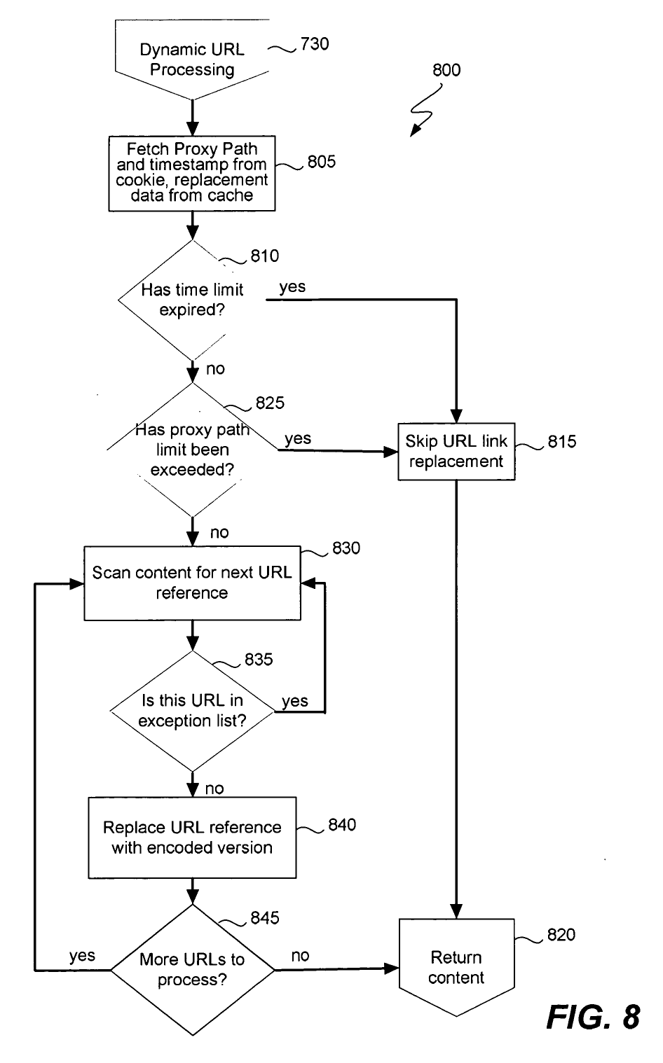

FIG. 4 shows a flow diagram of a method 400 for identifying and including web sites in a proxy web site group 350, performed in accordance with one embodiment of the present invention. The details of implementation of managing proxy group inclusion are provided by logic described below with reference to FIG. 8. The method 400 of FIG. 4 is described to illustrate a high level flow for including individual web sites in a proxy group. The method 400 begins in step 405 in which a browser program operated by a user 205, as shown in FIG. 2, references a web site. In FIG. 4, the method 400 proceeds to step 410 in which it is determined whether the referenced web site was previously defined in the proxy web site group 350. That is, in step 410, it is determined whether a proxy web site in the proxy group 350 has already been associated with the referenced web site. In step 410, for instance, when the user browser references the origin web site www.ford.com 310, it may be determined that proxy web site urlwww--ford--com.proxy.com 335 has already been defined in proxy web group 350. In this case, the method 400 proceeds from step 410 to completion in step 425.

In FIG. 4, returning to step 410, when it is determined that the referenced web site is not already represented in the proxy group 350, the method 400 proceeds to step 415 to determine whether the referenced web site satisfies certain proxy group criteria for inclusion in proxy group 350. The criteria applied in step 415 is described and explained below. In step 415, when the referenced domain does not satisfy the defined proxy group criteria, the method 400 proceeds to completion in step 425. Otherwise, returning to step 415, when the defined criteria for the proxy group 350 is satisfied, the referenced web site is included in the proxy web site group 350. That is, a proxy web site corresponding to the referenced web site is defined and included in the proxy web site group 350. For instance, when web site www.ford.com 310 is referenced for the first time, and the criteria in step 415 is satisfied, the proxy web site urlwww--ford--com.proxy.com 335 is created and included in proxy group 350.

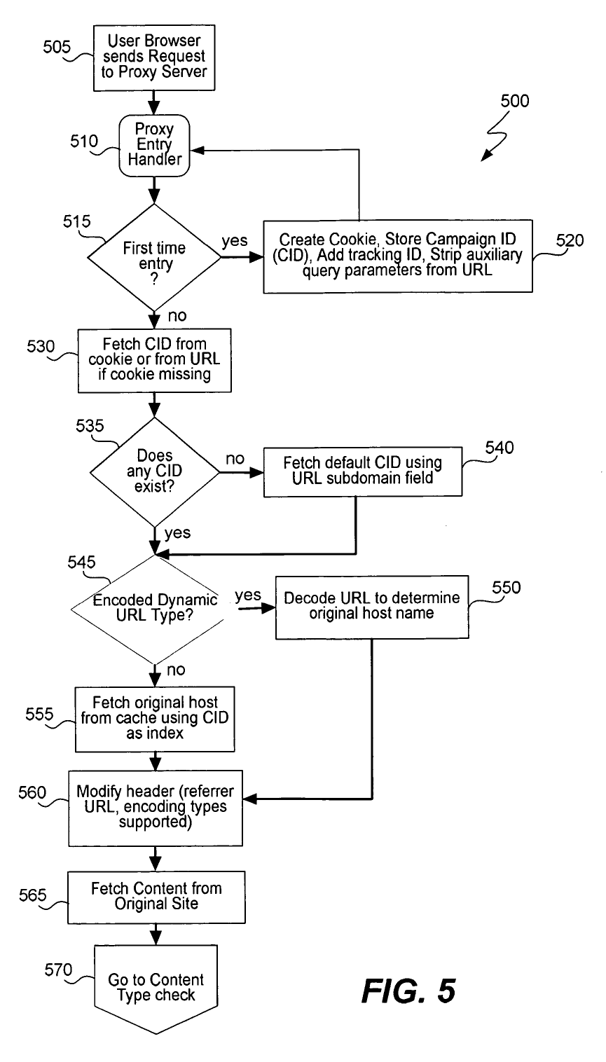

FIG. 5 shows a flow diagram of a method 500 of responding to a user request for advertiser data, performed by dynamic proxy server 225 in accordance with one embodiment of the present invention. The method 500 begins in step 505 in which the proxy server 225, as shown in FIG. 2, receives a request message requesting an advertiser web page at advertiser web site 210 from a browser program operated by potential customer 205. In one example, the browser request message is received through publisher 145 providing a hyperlink to the proxy server 225. For instance, an advertisement for “Rick's Ford” automobile dealership may be displayed on a popular publisher web site 145 such as google.com or yahoo.com. When the user clicks on the Rick's Ford link, the browser request message is routed to a corresponding URL at the proxy server 225.

In FIG. 5, following step 505, the method 500 proceeds to step 510 in which a proxy entry handler is executed, responsive to the browser request. The proxy entry handler processes the URL at the proxy server 225 corresponding to the requested entry site. For instance, in FIG. 3, the proxied URL ricksford.proxy.com corresponds to the requested origin entry site, www.ricksford.com. In this way, the proxy server 225 receives every request for content, e.g., pages, images, Flash objects, and other data, from the user browser 205.

In FIG. 5, following step 510, the method 500 proceeds to step 515 in which the proxy server 225 determines whether the request message of step 505 represents a first entry to the proxy server 225 or, alternatively, whether the particular browser program operated by the user has visited the proxy server 225 before. When the request message represents a first time entry for the user browser, the proxy server creates a cookie to be stored on the user computer 205. Thus, step 515 often involves checking to see whether a cookie exists on the user browser. In addition, in step 520, the proxy server stores in the cookie information passed from the user browser including a campaign ID or “CID,” timestamp, also referred herein as a tracking ID, and possibly other information. In addition, in step 520, the proxy server strips auxiliary query parameters from the URL. Following step 520, the method returns to step 510, described above.

In FIG. 5, in step 515, when the proxy server 225 determines that the browser request in step 505 does not represent a first time entry to the proxy server for the user, the method proceeds to step 530, in which a campaign ID is retrieved from the cookie stored in conjunction with the user browser program. The campaign ID value is used as a primary identifier for the online advertising campaign. Campaign IDs and their general use are described in U.S. patent application Ser. No. 10/956,824, filed Oct. 1, 2004 for METHOD AND APPARATUS FOR DYNAMICALLY RENDERING AN ADVERTISER WEB PAGE AS A PROXIED WEB PAGE (Attorney docket no. REACP005). In one embodiment, when the campaign ID is missing from the cookie, for instance, when cookies are disabled by the user browser program, the method can retrieve the campaign ID from the URL of the proxy server 225. For instance, the URL can be of the form: http://subdomain.proxy.com?CID=nnnn. Other optional query string parameters may follow in the URL. The CID value “nnnn” is generally included as a URL query string parameter. That is, in one embodiment, the URL includes the name of the proxy server as well as a campaign ID identifying the advertiser's online campaign for which user activity monitoring is desired.

In FIG. 5, in step 535, it is confirmed whether a campaign ID was passed through from the cookie or retrieved from the URL in step 530. In step 535, when no campaign ID exists, in one embodiment a default campaign ID can be retrieved from a URL sub-domain field. In this embodiment, the campaign ID was previously stored in a cache memory following its assignment to the particular campaign. In step 540, this stored campaign ID can be looked up by mapping the name of the advertiser or other identification information to the default campaign ID.

In FIG. 5, following step 540, or when a campaign ID is determined to exist in step 535, the method 500 proceeds to step 545. In step 545, the proxy server 225 determines whether the URL of the proxy URL is a special encoded type representing a dynamic URL, as explained below. In step 545, when the proxy server 225 determines that the URL is the encoded dynamic type, the method 500 proceeds to step 550 to decode the URL to determine the original host name, that is the origin web site corresponding to the encoded URL, as described above with respect to FIG. 3. Following step 550, the method 500 proceeds to step 560, described below.

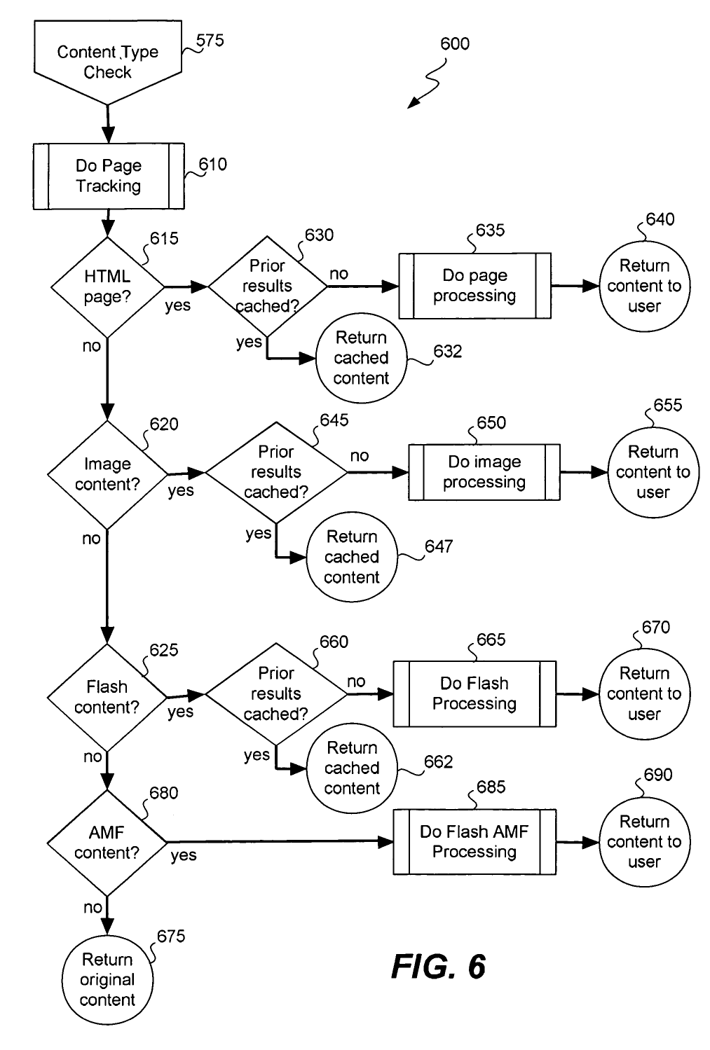

In FIG. 5, returning to step 545, when the proxy server 225 determines that the URL is not the encoded type, the method proceeds to step 555 to determine the URL of the original web site corresponding to the proxy URL. In one embodiment, in step 555, the campaign ID is used to look up this original web site in a cache memory storing the names of original web sites, and indexed by one or more campaign IDs. Following step 555, the method 500 proceeds to step 560, in which logic executes to ensure that the source or original web site identified in step 555 will operate properly with the modified URL. For instance, the proxy server needs to modify the HTTP request refer header to bypass some reference checking at the origin site; it can also modify the encoding type to indicate what encoding method the proxy server can handle. Following step 560, the method 500 proceeds to step 565, in which content from the original web site is retrieved, e.g. HTML pages, images, and Flash or AMF objects. Following step 565, the method 500 proceeds to step 570, to perform a content type check method described with reference to FIG. 6.

FIG. 6 shows a flow diagram of a method 600 of performing a content type check for content retrieved from an original web site in step 565 of FIG. 5, described above, according to one embodiment of the present invention. That is, the method 600 is performed to retrieve and process content from the original web site to deliver to the user browser. In FIG. 6, the method begins in step 610 in which a page tracking method can be performed, as described in U.S. patent application Ser. No. 10/956,824, filed Oct. 1, 2004 for METHOD AND APPARATUS FOR DYNAMICALLY RENDERING AN ADVERTISER WEB PAGE AS A PROXIED WEB PAGE (Attorney docket no. REACP005). That is, in some advertising campaigns, the URL of the original web site is one that is desirably recorded in the logs for campaign tracking. Such recording can be performed in step 610.

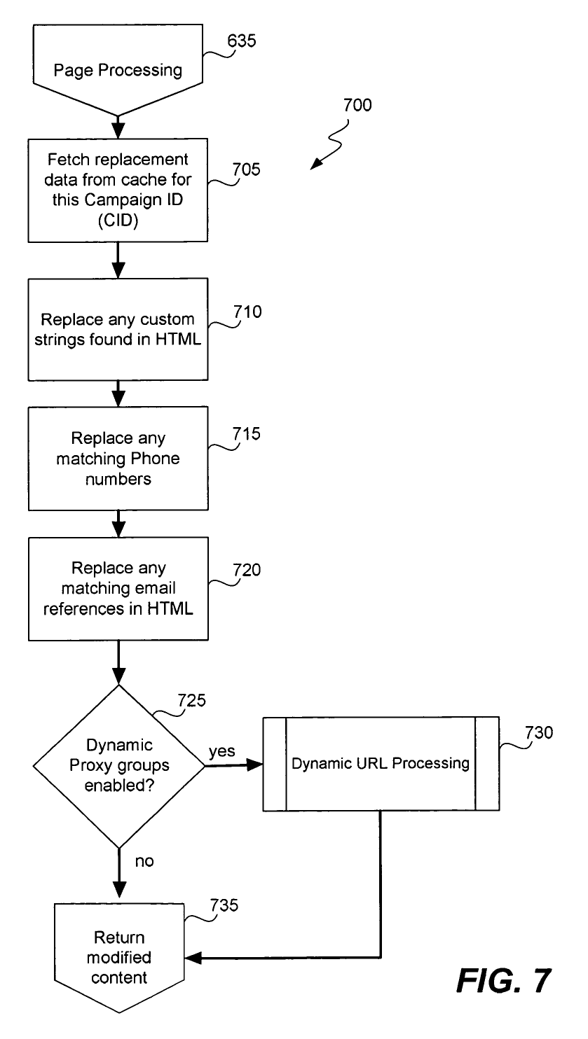

In FIG. 6, following step 610, the method 600 proceeds through steps 615, 620 and 625 to identify and process data retrieved from the original web site. For instance, following step 610, in step 615, the proxy server 225 determines whether the retrieved data is in the form of an HTML page. When the retrieved data is in the form of an HTML page, the method proceeds to step 630, to determine whether the particular HTML page was previously processed in accordance with a page processing method 635, described below with respect to FIG. 7, and stored in a cache memory for retrieval. When the particular HTML page has been processed, in step 630, the cached content of the processed page is retrieved and returned in step 632 of FIG. 6. When the page has not been processed, the page processing method 635, described below in FIG. 7, is performed. Following the page processing method 635, the processed content is returned to the user browser in step 640.

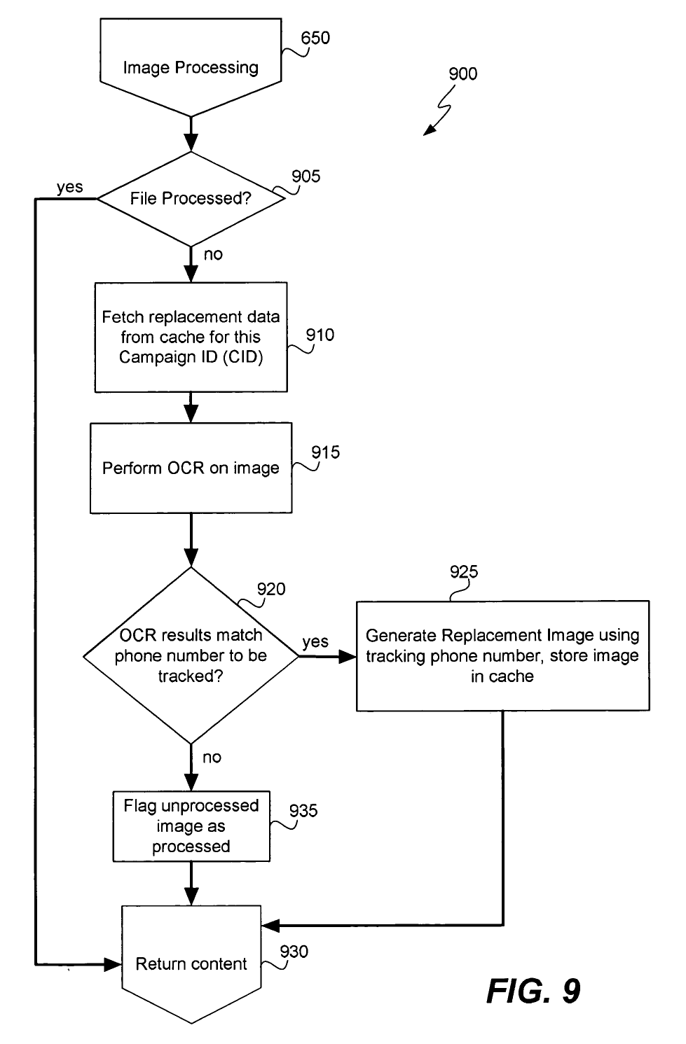

In FIG. 6, returning to step 615, when the retrieved content is not in the form of an HTML page, the method 600 proceeds to step 620, to determine whether the retrieved content is in the form of image data, e.g., GIF, JPEG, or PNG format. When the retrieved content is image data, the method proceeds from step 620 to step 645. Similar to step 630, in step 645, the proxy server 225 similarly determines whether the retrieved image data has already been processed and stored in cache memory. When prior results are not cached, the method proceeds to step 650 to perform an image processing method, described below in FIG. 9. Following step 650, the processed image data is returned to the user in step 655. Returning to step 645, when the image content has already been processed and cached, the method proceeds to step 647 to retrieved and return the cached image content to the user browser.

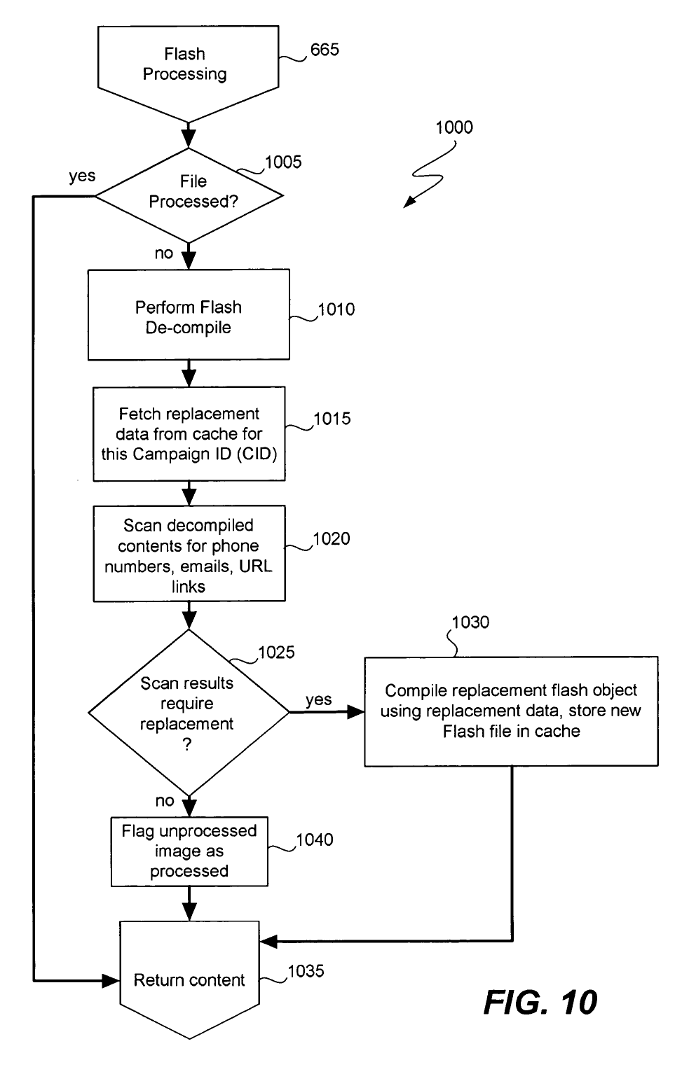

In FIG. 6, returning to step 620, when it is determined that the retrieved content is not image data, the method proceeds to step 625, in which it is determined whether the retrieved content is Flash data. When the retrieved content is identified as Flash data, the method proceeds to step 660 to determine whether the Flash or AMF content has already been processed and stored in cache memory. When the Flash content has not already been processed, the method proceeds from step 660 to step 665 to perform a Flash processing method, described below with respect to FIG. 10. Following the Flash processing 665, the processed Flash or AMF content is returned to the user browser in step 670. In step 660, when it is determined that the Flash processing method has already been performed on the retrieved data and stored in cache memory, the stored data is retrieved and returned to the user browser in step 662.

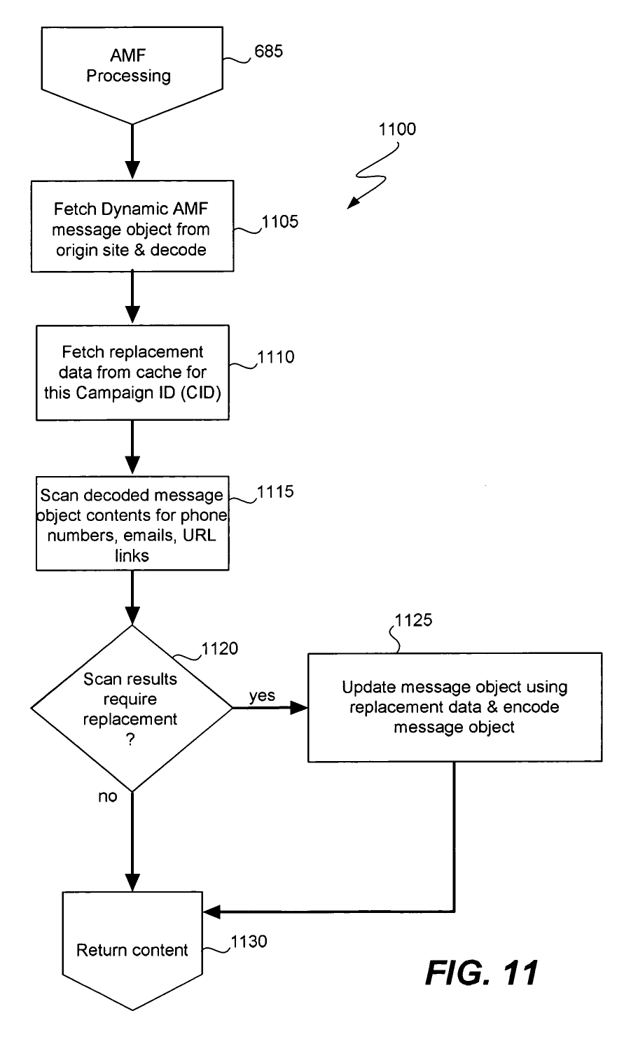

In FIG. 6, returning to step 625, when it is determined that the retrieved content is not Flash data, the method proceeds to step 680, in which it is determined whether the retrieved content is Flash AMF data. When the retrieved content is identified as Flash AMF data, the method proceeds to step 685 to perform a Flash AMF processing method, described below with respect to FIG. 11. Following the Flash AMF processing 685, the processed Flash AMF content is returned to the user browser in step 690.

In FIG. 6, returning to step 680, when it is determined that the retrieved content is not Flash AMF data, at this point it is clear that the retrieved data does not fall into the defined types of HTML data in step 615, image data in step 620, Flash data in step 625, or Flash AMF data in step 680. Thus, the method proceeds to step 675 to simply return the unprocessed original content from the original web site.

FIG. 7 shows flow diagram of a method 635 of performing HTML page processing, according to one embodiment of the present invention. The page processing method 635 begins in step 705 with retrieving replacement data for the particular campaign ID. That is, the proxy server retrieves tracking phone numbers, e-mail references, custom strings identifying any predefined text or script code pattern, and any other desired replacement data to be replaced on the retrieved page from the original web site. In one embodiment, such data can be stored in a memory device and looked-up in step 705 using the campaign ID as an index. Following step 705, the method 635 proceeds to steps 710, 715 and 720 to scan the page identified in step 615 of FIG. 6 and replace original data with the replacement data where appropriate. For instance, in step 710, any custom strings specifically identified in the replacement data, such as HTML code or java script on the page, are replaced. In step 710, the only URLs that are replaced in the identified HTML page are those that are specifically identified in custom strings in the replacement data. To provide additional URL checking and replacement, a dynamic method of URL identification and substitution is provided in steps 725 and 730, described below. In step 715, any phone numbers identified in the replacement data are replaced with campaign tracking phone numbers. In step 720, any matching e-mail references, such as a “mail to:” reference in the retrieved page is replaced with a tracking e-mail link.

In FIG. 7, following step 720, the method proceeds to step 725 to determine whether a dynamic proxy web group 350, described above with respect to FIG. 3, is enabled for this campaign ID. In one implementation, a parameter in memory has an “on” or “off” state indicating enablement or disablement of the dynamic proxy groups feature for the campaign ID. In step 725, when it is determined that dynamic proxy groups are enabled for the campaign ID, the method 635 proceeds to step 730 to perform a dynamic URL processing method, described below with reference to FIG. 8. The dynamic URL processing method 730 enables an unlimited number of URL's to be processed on the retrieved HTML page, that is, any and all URLs in addition to those specifically identified in a custom string in step 710.

In FIG. 7, in step 730, the dynamic URL processing method replaces URLs with proxy encoded URLs so that later, when a user browser receives the modified page and clicks on a replaced hyperlink on the modified page, the browser will be using an encoded URL in the hyperlink. In this way, regardless of the data type, e.g., page, image, Flash object, all such data will be fetched from the proxy server. This enables the proxy server to have control over the data retrieved by the user browser to accurately monitor the user's activity.

In FIG. 7, following step 730, the method proceeds to 735 to return the modified page, including all of the replaced content in steps 710, 715, 720, and 730, to the user browser. Similarly, returning to step 725, when dynamic proxy groups are not enabled, the method proceeds directly to step 735 to return the modified content to the user browser. When dynamic proxy groups are not enabled, only URLs handled in step 710 will be substituted by the proxy.

FIG. 8 shows a flow diagram of a dynamic URL processing method 730, performed in accordance with one embodiment of the present invention. The method 730 generally provides proxy group logic so that, as each page is scanned, URLs are checked and, as appropriate, replaced with an encoded URL which is associated with a proxy web site, for instance, in proxy group 350 of FIG. 3, that maps to its corresponding origin web site in origin group 325.

In FIG. 8, the method 730 begins in step 805 in which information stored in the cookie mentioned in steps 515 and 520 of FIG. 5 is retrieved, and any replacement data mentioned in step 705 of FIG. 7 is retrieved from cache memory. The information retrieved from the cookie includes a proxy path, that is, a list and/or sequence of domains clicked through by the user browser, generally starting with the entry web site entered by the user. In addition, the information retrieved from the cookie in step 805 includes a timestamp, indicating when the user browser first entered the entry web site. In step 805, the replacement data can identify images or Flash objects when images or Flash objects are referenced by a given URL on the page being processed. Otherwise, in instances where a URL references an HTML page, an exception list is generally retrieved rather than the replacement data, as further explained below.

In FIG. 8, following step 805, the method proceeds to steps 810 and 825 to determine whether criteria have been satisfied so that, in some instances, URLs are not replaced as appropriate. For instance, one criterion in step 810 is whether a time limit has expired for the session with that user browser. This time limit check in step 810 is performed using the timestamp retrieved in 805. For instance, when the proxy server 225 determines that N minutes have transpired since the last proxy path time stamp, dynamic URL substitution is desirably disabled. When the time limit has not expired, in step 810, the method proceeds to step 825 to determine whether the proxy path limit has been exceeded. Typically, additional sites to be included in an advertising campaign are directly referenced by the entry site or designated number of levels away. The proxy path limit specifies how many levels away from the entry site that dynamic link substitution is done. So, for instance, when the user browser is too far removed from the original entry site, for the purposes of monitoring the user activity in the campaign, it is determined that the user's activity is no longer relevant, and does not need to be monitored, and dynamic link substitution is not performed. In one embodiment, to optimize the proxy path limit, at which users essentially leave the campaign, the path from the origin site is stored in the cookie. In one embodiment, when the proxy server 225 stops dynamic link updates, an event is logged with the proxy path. This allows for later analysis to dynamically update and optimize the correct level for a given campaign. The determination in step 825 is made using the proxy path retrieved in step 805. Following steps 810 and 825, when either the time limit has expired or the proxy path limit has been exceeded, the method 730 proceeds to step 815, in which URL links are not replaced, and the original URLs in the origin web site page are returned in step 820.

In FIG. 8, returning to steps 810 and 825, when the criteria of time limits and proxy path limits have been satisfied, the method 730 proceeds to step 830, in which the content of the HTML page being processed is scanned to identify the next URL reference. Those skilled in the art will appreciate that the URL reference is essentially a network path which can identify any of various data, including hyperlinks to other pages, references to image sources, and Flash objects.

In step 830, following identification of the next URL reference on the page, in step 835, the proxy server 225 determines whether the URL is one listed in the exception list retrieved above in step 805. When the URL is identified in the exception list, the URL is to be ignored. Such identification on the exception list indicates that replacement is not desired for some reason, for instance, when the URL references an unrelated or undesired web site. In one embodiment, a default list of “do not proxy” sites is maintained as the exception list. In another embodiment, the exception list is customized by a provisioner to specify URLs to be included or excluded from URL replacement processing. When the identified URL is on the exception list, the method 730 proceeds from step 835 back to step 830 to identify the next URL reference on the retrieved page. In step 835, when the URL is not in the exception list, the method 730 proceeds to step 840 to replace the URL reference with an encoded version, for instance, as described above with reference to FIG. 3 in the format used for the proxy web sites 330-345 and proxy web site group 350.

In FIG. 8, following step 840, the method proceeds to step 845 to check whether there are additional URLs on the page to process. When there are additional URLs, the method returns to step 830 to identify the next URL reference on the page. In this way, the steps 830-845 loop until any and all URLs on the retrieved page are identified for possible replacement. In step 845, when there are no further URLs on the retrieved page to process, the method 730 proceeds to step 820 to return the content, including any URL replacements.

FIG. 9 shows a flow diagram of a method 650 for performing image processing, in accordance with one embodiment of the present invention. The method 650 begins in step 905, in which it is determined whether the retrieved image file has already been processed and stored in a memory, that is, with any replacements provided using the steps 910-935 described below. When the file has already been processed, the method proceeds from step 905 to step 930 to retrieve and return the already processed image data. In step 905, when the image file has not already been processed, the method 650 proceeds to step 910 in which any replacement data is retrieved from cache memory for the campaign ID requested by the user browser. Such replacement data can include image data, text, and other data as desired to be inserted in the image file.

In FIG. 9, following step 910, the method proceeds to step 915 in which, in one embodiment, an OCR technique is performed on the image to identify data for replacement. For instance, in step 920, the OCR technique can identify phone numbers embedded in the image file to be tracked. When such phone numbers are identified, the method proceeds from step 920 to step 925 to generate a replacement image with a tracking phone number replacing the identified phone number. That is, a tracking phone number fetched as part of the replacement data in step 910 is inserted in the image in place of the identified phone number. The modified image can then be stored in cache memory, in step 925, and then returned in step 930. Returning to step 920, when the OCR technique finds no matching phone numbers, the method proceeds to step 935 in which the unprocessed image is flagged as processed to facilitate later handling by the proxy server. Following step 935, the method proceeds to step 930 to return the processed image file.

FIG. 10 shows a flow diagram of a method 665 for performing Flash processing, in accordance with one embodiment of the present invention. The method 665 begins in step 1005 in which it is determined whether the identified Flash file has already been processed. When the file has been processed, the method proceeds to step 1035 to retrieve from memory the already processed Flash file. In step 1005, when the file has not already been processed, the method 665 proceeds to step 1010, in which the Flash object is decompiled using a conventional Flash decompiler program. Then, in step 1015, replacement data for the Flash object is retrieved from memory, using the campaign ID as an index to the memory in which the replacement data is stored. Then, in step 1020, the decompiled contents of the Flash object are scanned for any phone numbers, e-mail links, URL links, or other information desired to be replaced.

In FIG. 10, following step 1020, in step 1025, it is determined whether any of the decompiled contents scanned in step 1020 are desirably replaced with the replacement data of step 1015. When any such results are identified, the results are replaced, and the method proceeds to step 1030 in which the Flash object data is recompiled using the replacement data. A new Flash object file is stored in cache memory, and returned in step 1035. Returning to step 1025, when no results are identified, the original Flash object file is flagged as processed, in step 1040, and then returned as the deliverable content in step 1035.

FIG. 11 shows a flow diagram of a method 685 for performing Flash AMF processing, in accordance with one embodiment of the present invention. The method 685 begins in step 1105 in which the original Flash AMF message object is fetched and decoded using a conventional Flash AMF decoder program. Then, in step 1110, replacement data for the Flash AMF message object is retrieved from memory, using the campaign ID as an index to the memory in which the replacement data is stored. Then, in step 1115, the decoded contents of the Flash AMF message object are scanned for any phone numbers, e-mail links, URL links, or other information desired to be replaced.

In FIG. 11, following step 1115, in step 1120, it is determined whether any of the decoded contents scanned in step 1115 are desirably replaced with the replacement data of step 1110. When any such results are identified, the results are replaced, and the method proceeds to step 1125 in which the Flash AMF message object is recoded using the replacement data. Returning to step 1120, when no results are identified, the original Flash AMF message object is returned as the deliverable content in step 1130.

Embodiments of the invention, including the methods, apparatus, platform, servers, and engines described herein, can be implemented in digital electronic circuitry, or in computer hardware, firmware, software, or in combinations of them. Apparatus embodiments of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. Embodiments of the invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and Flash memory devices; magnetic disks such as internal hard disks and removable disks; magneto-optical disks; and CD-ROM disks. Any of the foregoing can be supplemented by, or incorporated in, ASICs (application-specific integrated circuits).

A number of implementations of the invention have been described. Nevertheless, it will be understood that various modifications may be made without departing from the spirit and scope of the invention. Accordingly, other embodiments are within the scope of the following claims.

What is claimed is:

1. A method for dynamic network address identification and replacement for delivering a web page to a data processing device associated with a customer, for performing a marketing campaign on behalf of an advertiser over a data network, the method comprising:
receiving a browser request message over the data network from a browser program executing on the data processing device, the browser request message requesting an origin web page at an origin web site on the data network, the origin web site associated with the advertiser;
determining a network address of the origin web site on the data network;
retrieving, responsive to the browser request message, content of the origin web page from the origin web site at the determined network address;
locating a network address in the retrieved content of the origin web page;
replacing the located network address with a proxy network address to define a modified web page, the proxy network address referencing a proxy web site on the data network; and
providing the modified web page to the data processing device over the data network.

2. The method of claim 1, wherein the network addresses are Uniform Resource Locators (URLs).

3. The method of claim 1, wherein the browser request message is generated responsive to customer selection of a link on a web page provided by an electronic publisher on the data network, the link associated with the advertiser.

4. The method of claim 1, the browser request message including an encoded network address, wherein determining the network address of the origin web site on the data network includes:
decoding the encoded network address to determine the network address of the origin web site.

5. A method for dynamic network address identification and replacement for delivering a web page to a data processing device associated with a customer, for performing a marketing campaign on behalf of an advertiser over a data network, the method comprising:
receiving a browser request message over the data network from a browser program executing on the data processing device, the browser request message requesting an origin web page at an origin web site on the data network, the origin web site associated with the advertiser;
determining a network address of the origin web site on the data network;
retrieving, responsive to the browser request message, content of the origin web page from the origin web site at the determined network address;
determining whether one or more limiting criteria are exceeded;
when it is determined that the one or more limiting criteria are exceeded:
providing the origin web page to the data processing device over the data network;
when it is determined that the one or more limiting criteria are not exceeded:
locating a network address in the retrieved content of the origin web page;
replacing the located network address with a proxy network address to define a modified web page, the proxy network address referencing a proxy web site on the data network;
providing the modified web page to the data processing device over the data network.

6. The method of claim 5, wherein the one or more limiting criteria include a time limit for a session of the browser program.

7. The method of claim 6, further comprising:
retrieving a time stamp from the data processing device;
computing a session time for the browser program based on the retrieved time stamp; and wherein:
determining whether the one or more limiting criteria are exceeded includes determining whether the session time exceeds the time limit.

8. The method of claim 5, wherein the one or more limiting criteria include a proxy path limit for a session of the browser program.

9. The method of claim 8, further comprising:
retrieving a proxy path from the data processing device;
determining a number of domains for the session of the browser program from the retrieved proxy path; and wherein:
determining whether the one or more limiting criteria are exceeded includes determining whether the number of domains for the session exceeds the proxy path limit.

10. The method of claim 5, when it is determined that the one or more limiting criteria are not exceeded, after locating the network address in the retrieved content of the origin web page, the method further comprising:
determining that the located network address is not identified in an exception list.

11. The method of claim 5, wherein the located network address references one selected from the group consisting of a web page, html data, text data, script data, a data object, a graphical object, image data, video data, and animation data.

12. A data processing apparatus for performing dynamic network address identification and replacement for delivering a web page to a data processing device associated with a customer, for a marketing campaign on behalf of an advertiser over a data network, the data processing apparatus comprising:
an interface in communication with the data network, the interface capable of receiving a browser request message from a browser program executing on the data processing device, the browser request message requesting an origin web page at an origin web site on the data network, the origin web site associated with the advertiser;
a memory storing instructions; and
a processor in communication with the interface and the memory, the processor operable to receive the browser request message from the interface, load the instructions from the memory responsive to receiving the browser request message, and execute the instructions to:
determine a network address of the origin web site on the data network,
retrieve, responsive to the browser request message, content of the origin web page from the origin web site at the determined network address,
determine whether one or more limiting criteria are exceeded,
when it is determined that the one or more limiting criteria are exceeded:
provide the origin web page to the data processing device over the data network,
when it is determined that the one or more limiting criteria are not exceeded:
locate a network address in the retrieved content of the origin web page;
replace the located network address with a proxy network address to define a modified web page, the proxy network address referencing a proxy web site on the data network;
provide the modified web page to the data processing device over the data network.

13. The data processing apparatus of claim 12, wherein the one or more limiting criteria include a time limit for a session of the browser program.

14. The data processing apparatus of claim 13, wherein the processor is further configured to execute the instructions to:
retrieve a time stamp from the data processing device;
compute a session time for the browser program based on the retrieved time stamp; and wherein:
determining whether the one or more limiting criteria are exceeded includes determining whether the session time exceeds the time limit.

15. The data processing apparatus of claim 12, wherein the one or more limiting criteria include a proxy path limit for a session of the browser program.

16. The data processing apparatus of claim 15, wherein the processor is further configured to execute the instructions to:
retrieve a proxy path from the data processing device;
determine a number of domains for the session of the browser program from the retrieved proxy path; and wherein:
determining whether the one or more limiting criteria are exceeded includes determining whether the number of domains for the session exceeds the proxy path limit.

17. The data processing apparatus of claim 12, wherein when it is determined that the one or more limiting criteria are not exceeded, after locating the network address in the retrieved content of the origin web page, the processor is further configured to execute the instructions to:
determine that the located network address is not identified in an exception list.

18. The data processing apparatus of claim 12, wherein the located network address references one selected from the group consisting of a web page, html data, text data, script data, a data object, a graphical object, image data, video data, and animation data.

19. A computer program product, stored on a processor readable medium, comprising instructions operable to cause a data processing apparatus to perform a method for dynamic network address identification and replacement for delivering a web page to a data processing device associated with a customer, for performing a marketing campaign on behalf of an advertiser over a data network, the method comprising:
receiving a browser request message over the data network from a browser program executing on the data processing device, the browser request message requesting an origin web page at an origin web site on the data network, the origin web site associated with the advertiser;
determining a network address of the origin web site on the data network;
retrieving, responsive to the browser request message, content of the origin web page from the origin web site at the determined network address;
determining whether one or more limiting criteria are exceeded;
when it is determined that the one or more limiting criteria are exceeded:
providing the origin web page to the data processing device over the data network;
when it is determined that the one or more limiting criteria are not exceeded:
locating a network address in the retrieved content of the origin web page;
replacing the located network address with a proxy network address to define a modified web page, the proxy network address referencing a proxy web site on the data network;
providing the modified web page to the data processing device over the data network.

20. The computer program product of claim 19, wherein the one or more limiting criteria include a time limit for a session of the browser program.

21. The computer program product of claim 20, the method further comprising:
retrieving a time stamp from the data processing device;
computing a session time for the browser program based on the retrieved time stamp; and wherein:
determining whether the one or more limiting criteria are exceeded includes determining whether the session time exceeds the time limit.

22. The computer program product of claim 19, wherein the one or more limiting criteria include a proxy path limit for a session of the browser program.

23. The computer program product of claim 22, the method further comprising:
retrieving a proxy path from the data processing device;
determining a number of domains for the session of the browser program from the retrieved proxy path; and wherein:
determining whether the one or more limiting criteria are exceeded includes determining whether the number of domains for the session exceeds the proxy path limit.

24. The computer program product of claim 19, wherein when it is determined that the one or more limiting criteria are not exceeded, after locating the network address in the retrieved content of the origin web page, the method further comprising:
determining that the located network address is not identified in an exception list.
